(19) United States
(12) Patent Application Publication
(10) Pub. No.: US 2008/0169901 A1
(43) Pub. Date: Jul. 17, 2008

(54) Arrangement for Identifying Persons

(75) Inventors: Volker Timm, Pinneberg (DE); Thomas Wille, Hamburg (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/572,793

(22) PCT Filed: Jun. 18, 2005
(86) PCT No.: PCT/IB2005/052376

§ 371 Date: Feb. 4, 2008

(30) Foreign Application Priority Data
Jul. 26, 2004 (EP) 04103559.3

(51) Int. Cl. G06K 19/07

(52) U.S. Cl. 340/5.81

(57) ABSTRACT

To provide an arrangement for identifying persons, comprising at least a one page or a multi-page identification document, particularly a passport (100), with at least one contactless RFID chip (20) and an antenna (22) connected thereto being integrated on its outer side, at least o: ie means for shielding electromagnetic waves is provided, which precludes unauthorized access to biometrical data.

The invention relates to an arrangement for identifying persons as defined in the pre-characterizing part of claim 1.

Identification documents such as, for example, passports are known in the state of the art. These documents show information about the identity and nationality of the passport owner and are needed for, for example, travels abroad. In the conventional passport, the personal data of the passport owner such as his name, address, age, etc. are printed on one page of the passport. Moreover, a passport comprises a photograph of the passport owner's face. In the future, biometrical data such as, for example, the digitized image of the passport owner, images of fingerprints and personal information will be stored on a contactless RFID chip which can be integrated on a polycarbonate or polyethylene page of the passport. An RFID system, which is known in the state of the art and consists of a transponder and a reading apparatus, is used for reading the biometrical data. The transponder, which acts as a data carrier, consists of an electronic microchip and a coupling element in the form of an antenna coil which allows an inductive coupling to the reading apparatus. Outside the response area of a reading apparatus, the transponder acts passively because it does not have its own energy supply. Within the response area of a reading apparatus, however, the transponder receives energy and a clock signal via the contactless coupling unit.

It is a problem that the chips embedded in the passport can be electronically read in a contactless way from a small distance when they are not shielded. To this end, only the mode of operation of the reading apparatus needs to be imitated. It is thus not ensured that biometrical data of the passport owner are only accessible to the authorized institutions.

The integration of an RFID chip in a multilayer cover sheet of a passport is known from US 2003/0,168,514. This document describes a method in which the embedding of the chips does not lead to a local variation of the thickness of the passport sheet.

US 2003/0,057,286 describes a passport comprising a microchip which is robustly integrated so as to prevent its destruction when the passport is folded or bent.

JP 11-348471 describes an arrangement in which a microchip is protected from unauthorized access when this microchip is situated on one of the inner pages of a multi-page document such as, for example, a passport. To this end, a shielding element is provided on one of the neighboring pages. Typically, this may be realized by depositing metallic materials having a high electric conductivity. When the passport is folded together, it is protected from unauthorized access. When the passport is unfolded, biometrical data can be read without any problem because the page having a metallic coating is sufficiently far remote from the microchip. The invention disclosed in said document does not provide any shielding of electromagnetic waves in the case where the microchip is provided on an outer side of the identification paper.

It is an object of the invention to make unauthorized access to biometrical data impossible also in the last-mentioned case.

According to the invention, this object is solved by means of an arrangement as defined in the characterizing part of claim 1.

Since the arrangement comprises at least one means for shielding electromagnetic waves, it is achieved that unauthorized access to the data stored on the microchip is also impossible when the microchip is provided on the outer side of the identification paper. Two different implementations are to be considered in this case. If the identification document consists of one page only, the invention can be realized in the most practical way by constituting the means for shielding electromagnetic waves as an envelope comprising a metal material, in which the identification document can be preserved. If the identification chip is embedded in one of the outer pages of the document, the electromagnetic waves can be shielded by a page of the identification document comprising a metal material. When the identification document is closed, the microchip is accessible but cannot be read because the page comprising a metal material influences the electromagnetic field. It is therefore irrelevant whether the shielding is in front of or behind the microchip. In the unfolded state of the identification document, the shielding page is turned away and reading is possible without any problem.

Further advantageous embodiments of the invention are defined in the dependent claims.

These and other aspects of the invention are apparent from and will be elucidated with reference to the embodiments described hereinafter.

In the drawings:

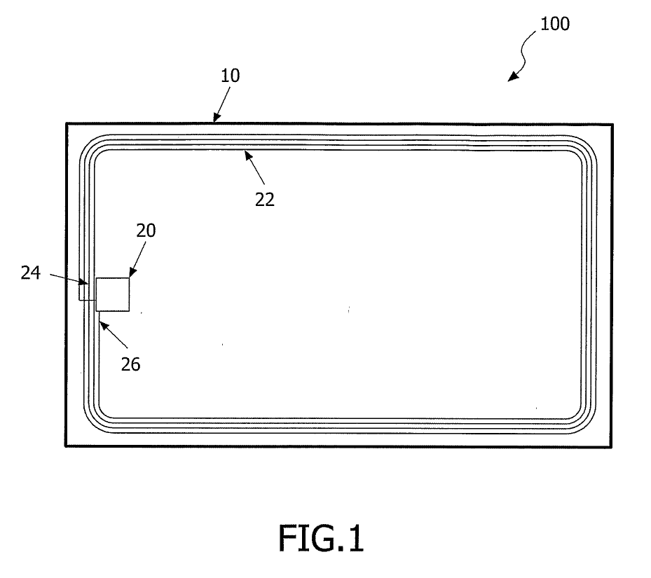

FIG. 1 is a plan view of an identification document with an integrated microchip;

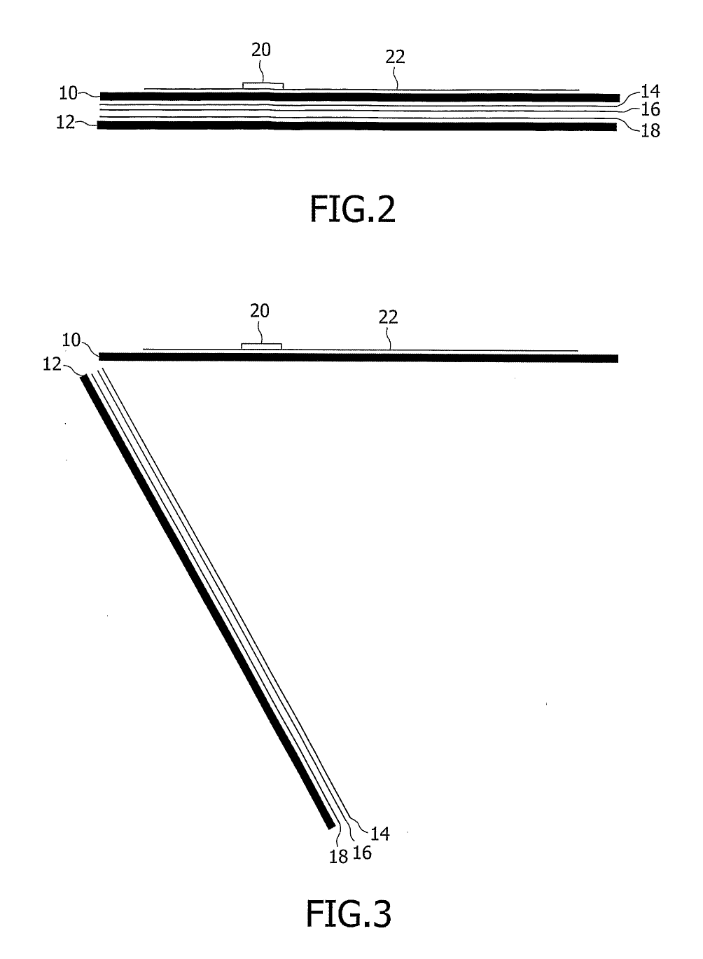

FIG. 2 is an elevational view of the passport according to the invention, in a folded state, and

FIG. 3 is an elevational view of the passport according to the invention, in an unfolded state.

FIG. 1 is a plan view of the passport according to the invention, denoted by reference numeral 100. A microchip 20, which stores the biometrical data of the passport owner, is integrated on the cover sheet 10. By means of the bonding wires 24 and 26, the microchip 20 is connected to a lateral coil 22 which represents a coupling element for the reading apparatus of the RFID system.

FIG. 2 is an elevational view of the passport according to the invention, in a folded state. A metal-coated page 14 is situated directly behind the cover sheet 10. When an electromagnetic field suitable for reading the microchip 20 is provided, the metal coating in the page 14 distorts the field in such a way that appropriate signal transmission is impossible. This is tantamount to a shielding of the electromagnetic waves. Further pages 16 and 18 as well as the rear cover sheet 12 do not modify the electromagnetic field.

FIG. 3 shows the passport 100 according to the invention, in an unfolded state. The metal-coated page 14 is now so far remote from the cover sheet 10 that the data can be read properly.

### LIST OF REFERENCE NUMERALS

100 passport
10 cover sheet
12 cover sheet
14 metal-coated page
16 further page
18 further page
20 microchip
22 lateral coil/antenna
24 bonding wire
26 bonding wire

1. An arrangement for identifying persons, comprising at least a one-page or a multi-page identification document, particularly a passport with at least one contactless RFID chip and an antenna connected thereto being integrated on its outer side, characterized by at least one means for shielding electromagnetic waves.

2. An arrangement as claimed in claim 1, characterized in that the means for shielding electromagnetic waves is an envelope comprising a metal material in which the identification document can be preserved.

3. An arrangement as claimed in claim 1, characterized in that the means for shielding electromagnetic waves is a page of the identification document comprising a metal material.

4. An arrangement as claimed in claim 3, characterized in that the identification document page comprising a metal material is the first page behind the outer side comprising the contactless RFID chip.

5. An arrangement as claimed in claim 3, characterized in that the identification document page comprising a metal material consists of a synthetic material foil which is clad or vapor-deposited with aluminum.
